(19) United States
(12) Patent Application Publication
(10) Pub. No.: US 2019/0227940 A1
(43) Pub. Date: Jul. 25, 2019

(54) MEMORY SYSTEM AND OPERATING METHOD THEREOF

(71) Applicant: SK hynix Inc., Gyeonggi-do (KR)

(72) Inventor: Jee Yul KIM, Gyeonggi-do (KR)

(21) Appl. No.: 16/116,284

(22) Filed: Aug. 29, 2018

(30) Foreign Application Priority Data
Jan. 25, 2018 (KR) 10-2018-0009567

(51) Int. Cl. G06F 12/0873

(52) U.S. Cl. CPC G06F 12/0873; G06F 2212/27; G06F 2212/222; G06F 2212/305

(57) ABSTRACT

A memory system includes a nonvolatile memory device configured to store a plurality of segments each of which is configured by a plurality of map data, a first region configured to cache a target segment including target map data among the plurality of segments, a second region configured to cache a target map data group selected among a plurality of map data groups in the target segment and a controller configured to control data caching of the first region and the second region, wherein each of plurality of map data groups includes a plurality of map data, and the second region caches data of a unit smaller than the first region.

### CROSS-REFERENCE TO RELATED APPLICATION

The present application claims priority under 35 U.S.C. § 119(a) to Korean application number 10-2018-0009567, filed on Jan. 25, 2018, in the Korean Intellectual Property Office, which is incorporated herein by reference in its entirety.

### BACKGROUND

### 1. Technical Field

Various embodiments of the present invention generally relate to a memory system. Particularly, the embodiments relate to a memory system including a nonvolatile memory device.

### 2. Related Art

A memory system may be configured to store data provided from an external device in response to a write request from the external device. Also, the memory system may be configured to provide stored data to the external device in response to a read request from the external device. The external device, which is capable of processing data, may include a computer, a digital camera or a mobile phone. The memory system may operate within or as a component of the external device, or may operate as a separate component coupled to the external device.

Since there is no mechanical driving part, a memory system using a memory device provides advantages such as excellent stability and durability, high information access speed, and low power consumption. Memory systems having such advantages include a universal serial bus (USB) memory device, memory cards having various interfaces, a universal flash storage (UFS) device, and a solid state drive (SSD).

### SUMMARY

Various embodiments are directed to a memory system which uses a plurality of regions having different units for caching map data, thereby increasing the utilization efficiency of a cache memory.

In an embodiment, a memory system may include: a nonvolatile memory device configured to store a plurality of segments each of which is configured by a plurality of map data; a first region configured to cache a target segment including target map data among plurality of the segments; a second region configured to cache a target map data group selected among a plurality of map data groups in the target segment; and a controller configured to control data caching of the first region and the second region, wherein each of plurality of map data groups includes a plurality of map data, and the second region caches data of a unit smaller than the first region.

In an embodiment, a method for operating a memory system may include: searching, when a controller receives a read request for read data from a host device, a first region or a second region for target map data for an area where the read data is stored; receiving, when the target map data is not stored in the first region and the second region, a target segment including the target map data from a nonvolatile memory device, by the controller; storing the target segment in the first region; selecting a target map data group among a plurality of map data groups in the target segment; and storing the target map data group in the second region which caches data of a unit smaller than the first region, wherein the target map data group includes the target map data.

In the memory system according to the embodiment, by using a plurality of regions having different units for caching map data, it is possible to improve the utilization efficiency of a cache memory.

In an embodiment, a memory system comprising: a memory device configured to manage a plurality of map segments each including a plurality of map groups each having a plurality of map data; a first cache configured to cache one or more among the map segments stored in the memory device in units of segments; a second cache configured to cache one or more among the map groups cached in the first cache in units of map groups; and a controller configured to: find, in response to a read request, target map data from the second cache, the first cache, and then the memory device; control the memory device to perform a read operation according to the target map data; and control the first and second caches to respectively cache a segment and a map group including the target map data.

In an embodiment, the first region and the second region is configured by a static random access memory (SRAM).

### BRIEF DESCRIPTION OF THE DRAWINGS

FIG. 1 is a block diagram illustrating a configuration of a memory system in accordance with an embodiment.

FIG. 2 is a diagram to assist in the explanation of the relationships of segments, map data groups and map data in accordance with an embodiment.

FIG. 3 is a diagram to assist in the explanation of a process in which a target map data group is stored in a second region in accordance with an embodiment.

FIG. 4 is a diagram to assist in the explanation of a process in which a target segment and a target map data group are stored in a first region and a second region, respectively, when the first region and the second region are full, in accordance with an embodiment.

FIG. 5 is a diagram to assist in the explanation of a process in which target segments are stored in a first region when the size of map data is greater than or equal to the storage capacity of a second region, in accordance with an embodiment.

FIGS. 6 and 7 are flow charts to assist in the explanation of methods for operating a memory system in accordance with embodiments.

FIG. 8 is a diagram illustrating a data processing system including a solid state drive (SSD) in accordance with an embodiment.

FIG. 9 is a diagram illustrating a data processing system including a memory system in accordance with an embodiment.

FIG. 10 is a diagram illustrating a data processing system including a memory system in accordance with an embodiment.

FIG. 11 is a diagram illustrating a network system including a memory system in accordance with an embodiment.

FIG. 12 is a block diagram illustrating a nonvolatile memory device included in a memory system in accordance with an embodiment.

### DETAILED DESCRIPTION

In the present invention, advantages, features and methods for achieving them will become more apparent after reading the following description of embodiments taken in conjunction with the drawings. The present invention may, however, be embodied in different forms and thus is not limited to the embodiments set forth herein. Rather, these embodiments are provided to describe the present invention in detail to the extent that a person skilled in the art to which the invention pertains can easily practice the present invention.

It is to be understood that embodiments of the present invention are not limited to the particulars shown in the drawings and that the drawings are not necessarily to scale and, in some instances, proportions may have been exaggerated in order to more clearly depict certain features of the invention. While particular terminology is used herein, it is to be appreciated that such terminology is for the purpose of describing particular embodiments and is not intended to limit the scope of the present invention. Moreover, throughout the specification, reference to “an embodiment” or the like is not necessarily to only one embodiment, and different references to “an embodiment” or the like are not necessarily to the same embodiment(s).

As used herein, the term “and/or” includes any and all combinations of one or more of the associated listed items. It will be understood that when an element is referred to as being “on,” “connected to” or “coupled to” another element, it may be directly on, connected or coupled to the other element or one or more intervening elements may be present. As used herein, a singular form is intended to include the plural form and vice versa, unless the context clearly indicates otherwise. It will be further understood that the terms “includes” and/or “including,” when used in this specification, specify the presence of at least one stated feature, step, operation, and/or element, but do not preclude the presence or addition of one or more other features, steps, operations, and/or elements.

A memory system and an operating method thereof will be described below with reference to the accompanying drawings through various embodiments.

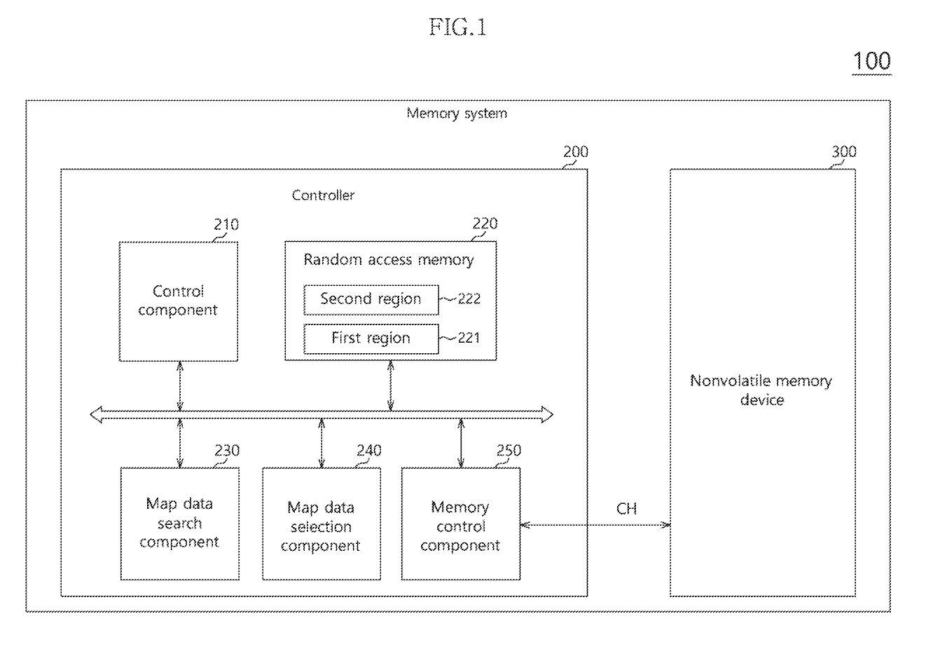

FIG. 1 is a block diagram illustrating a configuration of a memory system in accordance with an embodiment.

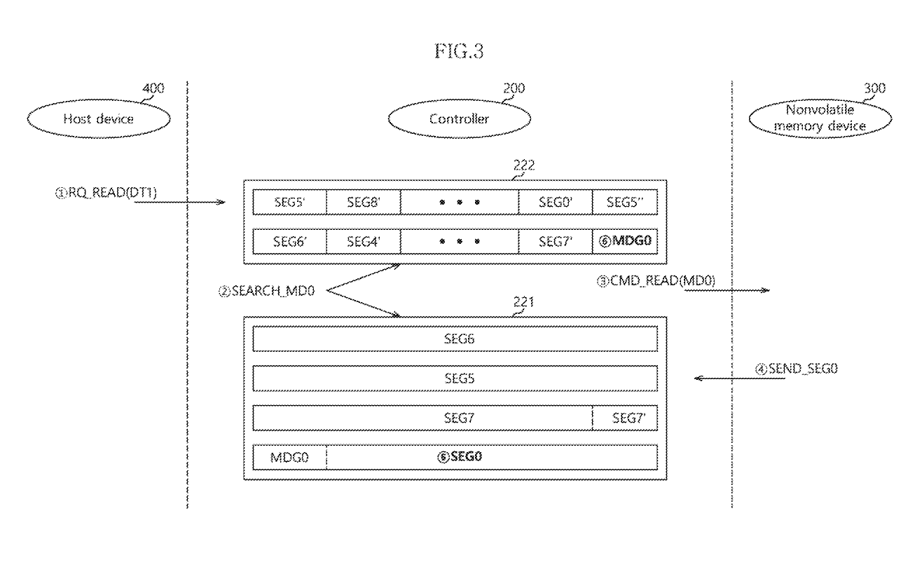

The memory system 100 may store data to be accessed by a host device 400 (see FIG. 3) such as a mobile phone, an MP3 player, a laptop computer, a desktop computer, a game player, a TV, an in-vehicle infotainment system, and the like.

The memory system 100 may be configured as any one of various kinds of storage devices according to a transmission protocol with the host device 400. For example, the memory system 100 may be configured as any one of a solid state drive (SSD), a multimedia card in the form of an MMC, an eMMC, an RS-MMC and a micro-MMC, a secure digital card in the form of an SD, a mini-SD and a micro-SD, a universal serial bus (USB) storage device, a universal flash storage (UFS) device, a Personal Computer Memory Card International Association (PCMCIA) card type storage device, a peripheral component interconnection (PCI) card type storage device, a PCI express (PCI-E) card type storage device, a compact flash (CF) card, a smart media card, a memory stick, and the like.

The memory system 100 may be manufactured as any one of various package types. For example, the memory system 100 may be manufactured as any one of a package-on-package (POP), a system-in-package (SIP), a system-on-chip (SOC), a multi-chip package (MCP), a chip-on-board (COB), a wafer-level fabricated package (WFP) and a wafer-level stack package (WSP).

The memory system 100 may include a controller 200 and a nonvolatile memory device 300. The controller 200 may include a control component 210, a random access memory 220, a map data search component 230, a map data selection component 240 and a memory control component 250.

The control component 210 may be configured by circuits or other hardware embodying a micro control unit (MCU) or a central processing unit (CPU). The control component 210 may process a request which is transmitted from the host device 400. In order to process the request, the control component 210 may drive an instruction or algorithm of a code type, that is, firmware (FW), loaded in the random access memory 220, and may control internal function blocks and the nonvolatile memory device 300.

The random access memory 220 may be configured as a dynamic random access memory (DRAM) or a static random access memory (SRAM). The random access memory 220 may store the firmware (FW) which is driven by the control component 210. Also, the random access memory 220 may store data for driving the firmware (FW), for example, metadata. That is to say, the random access memory 220 may operate as the working memory of the control component 210.

The random access memory 220 may include a first region 221 and a second region 222. While the first region 221 and the second region 222 may be configured by SRAMs, it is to be noted that present invention is not limited thereto; other types of memories storing data may be used.

The first region 221 may store segments received from the nonvolatile memory device 300. Each of the segments may include a plurality of map data groups, and each of the map data groups may include a plurality of map data. The first region 221 may serve as a map cache. In detail, the first region 221 may store a segment including map data which is hit at least once. When a segment that includes map data corresponding to a requested address is stored in the first region 221, the control component 210 may perform an operation using the map data in the segment stored in the first region 221.

The second region 222 may store map data groups which are received from the first region 221. Each of the map data groups may include a plurality of map data. Similarly to the first region 221, the second region 222 may serve as a map cache. In detail, the second region 222 may store map data groups each of which includes map data hit at least once. When a map data group which includes map data corresponding to a requested address is stored in the second region 222, the control component 210 may perform an operation using the map data in the map data group stored in the second region 222.

The map data search component 230 may search whether or not target map data is stored in the first region 221 or the second region 222, under the control of the control component 210. Detailed description of an operation performed by the map data search component 230 will be described later.

The map data selection component 240 selects a target map data group to be stored in the second region 222, among the map data groups in a segment stored or to be stored in the first region 221. Detailed description of an operation performed by the map data selection component 240 will be described later.

The memory control component 250 may interface with the nonvolatile memory device 300 and control driving of the nonvolatile memory device 300 according to the control of the control component 210. The memory control component 250 may also be referred to as a memory interface. The memory control component 250 may provide control signals to the nonvolatile memory device 300. The control signals may include a command, an address, a control signal and the like for controlling the nonvolatile memory device 300. The memory control component 250 may provide data to the nonvolatile memory device 300 or may be provided with data from the nonvolatile memory device 300.

The host interface (not shown) may interface the host device 400 and the memory system 100. For instance, the host interface may communicate with the host device 400 through any one of standard transmission protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-E) and universal flash storage (UFS).

The nonvolatile memory device 300 may be configured as any one of various types of nonvolatile memory devices such as a NAND flash memory device, a NOR flash memory device, a ferroelectric random access memory (FRAM) using a ferroelectric capacitor, a magnetic random access memory (MRAM) using a tunneling magneto-resistive (TMR) layer, a phase change random access memory (PCRAM) using a chalcogenide alloy, and a resistive random access memory (RERAM) using a transition metal oxide.

The nonvolatile memory device 300 may include a memory cell array. From an operational viewpoint or a physical (or structural) viewpoint, the memory cells included in the memory cell array may be configured as a hierarchical memory cell set or a memory cell unit. For example, memory cells which are coupled to the same word line and are to be read and written (or programmed) simultaneously may be configured as a page. In the following description, memory cells configured as a page are referred to as a “page.” Also, memory cells to be erased simultaneously may be configured as a memory block. The memory cell array may include a plurality of memory blocks, and each of the memory blocks may include a plurality of pages.

The controller 200 may generate a mapping information and a sequence information on a logical address provided from an external device. The nonvolatile memory device 300 may operate in a physical address system different from the logical address system recognized by the external device (e.g., the host device 400) due to its structural characteristics. For this reason, the controller 200 may generate plural pieces of mapping information indicating the corresponding relationships between logical addresses and physical addresses, convert a logical address provided from the external device into the physical address mapped thereto, and provide the converted physical address to the nonvolatile memory device 300.

The controller 200 may construct at least one of a logical-to-physical (L2P) mapping table and a physical-to-logical (P2L) mapping table in the random access memory 220, based on the plural pieces of mapping information on logical addresses. The controller 200 may back up the constructed mapping table from the random access memory 220 to the nonvolatile memory device 300.

In the present specification, one map data may mean a single piece of mapping information on one logical address. Each of map data groups may include a plurality of map data, and each of segments may include a plurality of map data groups.

If map data corresponding to all logical addresses are stored in the random access memory 220, when performing an operation in response to a read request or the like of the host device 400, information on an address where data is stored may be known from the information stored in the random access memory 220, in which case an operation of reading map data from the nonvolatile memory device 300 is not necessary.

However, in recent years, as a consequence of the miniaturization trend, the number of memories in the controller 200 is decreasing; accordingly, it is becoming more common that map data is not stored in the random access memory 220. In this case, necessary map data is read from the nonvolatile memory device 300, and a read operation or the like is performed based on the read map data. When reading map data from the nonvolatile memory device 300, the reading is performed on the segment including a plurality of map data, as a unit. In order to prevent frequent loading and performance deterioration due to frequent map data read operations, a segment which is read is cached in a map cache (or a map buffer), and, in the case where map data in the segment stored in the map cache is necessary, an operation is performed based on the map data stored in the map cache without an operation of reading the map data from the nonvolatile memory device 300.

Nevertheless, due to the limited capacity of the map cache, in the case where a plurality of segments are read, a certain segment may be quickly erased from the map cache. As a result, a problem may be caused in that, in the case of a segment including map data which is frequently needed, it is necessary to frequently read the segment from the nonvolatile memory device 300.

To address such a problem, a method has been proposed in which a map cache is divided into two regions and a segment including map data having a high count of hits is separately stored for a set or predetermined period. Nonetheless, there is a problem that, since storage is performed on the entire segment as a unit even though map data to be hit is a substantially small portion among the map data in one segment, storage space is inefficiently used.

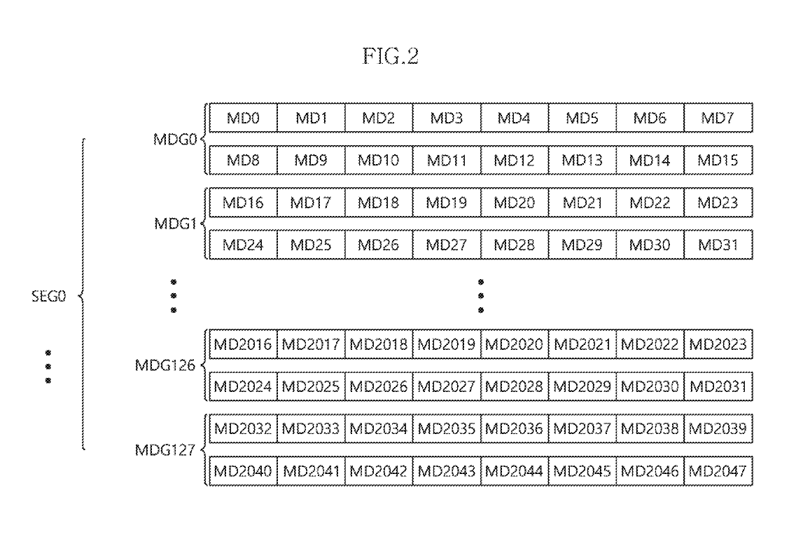

FIG. 2 is a diagram to assist in the explanation of the relationships of segments, map data groups and map data. As described above, in the present specification, one map data may mean mapping information on one logical address.

Referring to FIG. 2, one map data group may include a plurality of map data. For instance, a map data group MDG0 may include map data MD0 to map data MD15. That is, 16 map data may be included in one map data group. Also, one segment may include a plurality of map data groups. For instance, a segment SEG0 may include map data group MDG0 to map data group MDG127. In other words, 128 map data groups may be included in one segment, and accordingly, 2048 map data may be included in one segment. These numbers are exemplary. The number of map data groups in a segment and the number of map data in each map data group may be changed as the need arises. For instance, the size of each segment may be set to the size of a page, which is a unit by which data is written in the nonvolatile memory device 300.

FIG. 3 is a diagram to assist in the explanation of a process in which a target map data group is stored in the second region 222 in accordance with an embodiment. A reference symbol SEGn′ or SEGn″ indicates a map data group which is included in a segment SEGn (n is an integer equal to or greater than 0) and includes previously requested target map data. For example, the reference symbol SEG7′ stored in the second region 222 of FIG. 3 means a target map data group when a segment SEG7 is stored in the first region 221.

In the description of FIGS. 3 to 5, the following conditions are assumed. The first region 221 has a capacity capable of storing four segments, and the second region 222 has a capacity capable of storing 16 map data groups. Also, in the description of FIG. 3, it is assumed that three segments SEG6, SEG5 and SEG7 are currently stored in the first region 221 and 15 map data groups SEG5′, SEG8′, . . . , SEG0′, SEG5″, SEG6′, SEG4′, . . . , SEG7′ are currently stored in the second region 222.

The memory system 100 in accordance with an embodiment may include the nonvolatile memory device 300 which stores a plurality of segments each configured by a plurality of map data, the first region 221 which caches a target segment including target map data among the segments, the second region 222 which caches a target map data group selected among the plurality of map data groups included in the target segment, and the control component 210 which controls the data caching of the first region 221 and the second region 222. It is assumed that each of map data groups may include a plurality of map data, and the second region 222 caches data in smaller units than the first region 221. Target map data is defined as mapping data corresponding to a physical address where read-requested data is stored in the nonvolatile memory device 300.

At step \textcircled{1}, the controller 200 may receive a read request RQ_READ(DT1) for first data DT1 from the host device 400.

According to an embodiment, the controller 200 may include the map data search component 230 which searches the first region 221 and/or the second region 222 for target map data. At step \textcircled{2}, the map data search component 230 may search the first region 221 and/or the second region 222 for the map data MD0 for the read-requested first data DT1. In detail, the map data search component 230 may search the plurality of segments stored in the first region 221 for a segment including the map data MD0, and, in the case where the segment is not stored in the first region 221, may search the plurality of map data groups stored in the second region 222 for the map data group including the map data MD0. However, orders in which the first region 221 and the second region 222 are searched may be changed or may be performed simultaneously. According to an embodiment, it is assumed that the map data MD0 is not stored in the first region 221 or the second region 222, and hence not located by the map data search component 230.

At step \textcircled{3}, the controller 200 may transmit a read command CMD_READ(MD0) for the map data MD0 to the nonvolatile memory device 300 through the memory control component 250. Namely, the memory system 100 in accordance with an embodiment may include the memory control component 250 which transmits the read command CMD_READ(MD0) for target map data (i.e., the map data MD0 of FIG. 3) to the nonvolatile memory device 300, when it is determined that the target map data is not stored in the first region 221 or the second region 222.

At step \textcircled{4}, the controller 200 may receive the segment SEG0 including the map data MD0 from the nonvolatile memory device 300. In general, map data are stored with its entire segment as a unit in the nonvolatile memory device 300, and a segment including target map data is transmitted to the controller 200. While the segment unit may be the page unit of a nonvolatile memory, it is not limited thereto; the segment unit may be of any suitable size.

At step \textcircled{5}, the control component 210 may store the segment SEG0 received from the nonvolatile memory device 300 in the first region 221.

According to an embodiment, the controller 200 may include the map data selection component 240 which selects a target map data group to be stored in the second region 222 from the segment stored or to be stored in the first region 221. The map data selection component 240 may select a target map data group when the sum of the hit counts of the plurality of map data in one map data group is equal to or greater than a reference count. For instance, it is assumed that the reference count is 1.

At step \textcircled{6}, the map data selection component 240 may select the map data group MDG0 as a target map data group. In detail, the map data group MDG0 includes the map data MD0 having mapping information between logical and physical addresses for the read-requested first data DT1, and, based on this, may be selected as a target map data group. The control component 210 controls the map data group MDG0 selected as a target map data group to be stored in the second region 222.

According to an embodiment, a time at which the map data group MDG0 is stored in the second region 222 may be adjusted. For example, after the segment SEG0 is stored in the first region 221, the map data group MDG0 may be stored in the second region 222. Alternatively, after the map data group MDG0 is stored in the second region 222, the segment SEG0 may be stored in the first region 221. According to an embodiment, the operation in which the segment SEG0 is stored in the first region 221 and the operation in which the map data group MDG0 is stored in the second region 222 may be performed simultaneously. According to an embodiment, after the segment SEG0 is stored in the first region 221 and a read operation for the first data DT1 is performed based on the segment SEG0, the map data group MDG0 may be stored in the second region 222. In another embodiment, when the first region 221 is full of segments, the target map data groups respectively included in the segments stored in the first region 221 may be controlled to be stored in the second region 222.

According to an embodiment, based on one read request, a plurality of segments may be stored in the first region 221 or a plurality of map data groups may be stored in the second region 222. For example, in the case where a plurality of map data are required for the read-requested first data DT1 and the plurality of map data are in a plurality of map data groups and segments, the respective target map data groups and respective target segments may be stored in the second region 222 and the first region 221 in the same manner as described above.

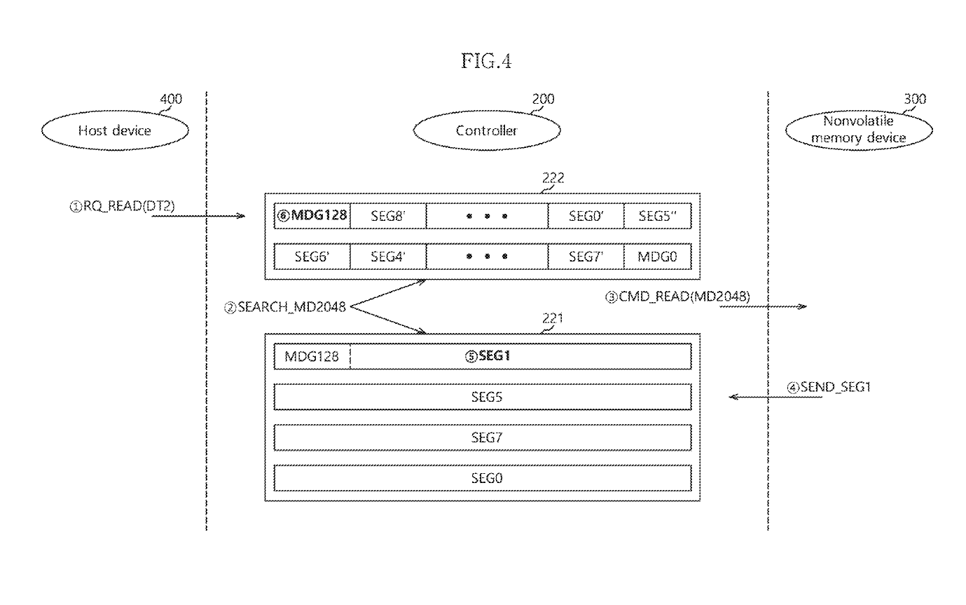

FIG. 4 is a diagram to assist in the explanation of a process in which a target segment and a target map data group are stored in the first region 221 and the second region 222, respectively, when the first region and the second region are full, in accordance with an embodiment. In describing FIG. 4, it is assumed that the first region 221 becomes full by storing the segment SEG0 and the second region 222 also becomes full by storing the map data group MDG0, as described with reference to FIG. 3.

At steps \textcircled{1} to \textcircled{4}, operations corresponding to the operations described above with reference to FIG. 3 may be performed. In other words, the controller 200 may receive a read request RQ_READ(DT2) for second data DT2 from the host device 400, the map data search component 230 may search the first region 221 and/or the second region 222 for map data MD2048 as a target map data for the read-requested second data DT2, and it is determined as a result of the search that the map data MD2048 is not stored in the first region 221 or the second region 222. Thereafter, a read command CMD_READ(MD2048) for the map data MD2048 may be transmitted to the nonvolatile memory device 300 through the memory control component 250, and a segment SEG1 including the map data MD2048 may be received from the nonvolatile memory device 300.

At step \textcircled{5}, the control component 210 may control the segment SEG1 received from the nonvolatile memory device 300, to be stored in the first region 221. As assumed above, the storage capacity of the first region 221 is already full. According to an embodiment, the control component 210 may control the segment SEG1 as a target segment, to be stored in an area where the oldest segment is stored in the first region 221. In another embodiment, the control component 210 may determine hit counts of the segments stored in the first region 221, and may control the segment SEG1 to be stored in an area of the first region 221 where a segment having the lowest hit count is stored.

At step \textcircled{6}, the map data selection component 240 may select a map data group MDG128 as a target map data group. In detail, the map data group MDG128 includes the map data MD2048 for the read-requested second data DT2, and, based on this, may be selected as a target map data group. The control component 210 controls the map data group MDG128 selected as a target map data group to be stored in the second region 222. As assumed above, the storage capacity of the second region 222 is already full. According to an embodiment, the control component 210 may control the map data group MDG128 to be stored in an area where the oldest map data group is stored in the second region 222. According to another embodiment, the control component 210 may determine hit counts of the map data groups stored in the second region 222, and may control the map data group MDG128 to be stored in an area of the second region 222 where a map data group having the lowest hit count is stored.

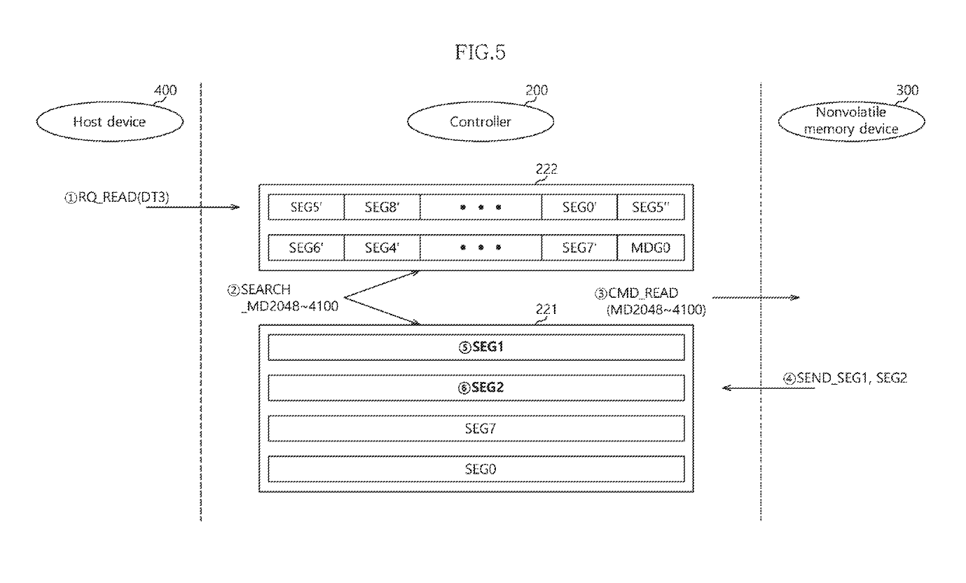

FIG. 5 is a diagram to assist in the explanation of a process in which target segments are stored in the first region 221 when the size of map data is equal to or larger than the storage capacity of the second region 222, in accordance with an embodiment. In describing FIG. 5, it is assumed that the first region 221 becomes full by storing the segment SEG0 and the second region 222 also becomes full by storing the map data group MDG0, as described with reference to FIG. 3.

At steps \textcircled{1} to \textcircled{4}, operations corresponding to the operations described above with reference to FIG. 3 may be performed. Namely, the controller 200 receives a read request RQ_READ(DT3) for third data DT3 from the host device 400. In this regard, it is assumed that the number of map data corresponding to addresses where the third data DT3 is stored is plural and, for instance, map data MD2048 to map data MD4100 correspond to the addresses where the third data DT3 is stored. Referring to FIG. 2, the map data MD2048 to the map data MD4100 are included in a plurality of segments (e.g., the segment SEG1 and a segment SEG2). The map data search component 230 may search the first region 221 or the second region 222 for the map data MD2048 to the map data MD4100 as target map data for the read-requested third data DT3, and it is assumed that it is determined as a result of the search that the map data MD2048 to the map data MD4100 are not stored in the first region 221 or the second region 222. Thereafter, a read command CMD_READ(MD2048˜4100) for the map data MD2048 to the map data MD4100 may be transmitted to the nonvolatile memory device 300 through the memory control component 250, and the segment SEG1 and the segment SEG2 including the map data MD2048 to the map data 4100 may be received from the nonvolatile memory device 300.

At steps \textcircled{5} and \textcircled{6}, the control component 210 may control the segment SEG1 and the segment SEG2 received from the nonvolatile memory device 300 to be stored in the first region 221. As assumed above, since the first region 221 is already full, the segment SEG1 and the segment SEG2 may be stored in areas where two segments selected according to a set or predetermined condition are stored. The condition may be applied in the same manner as described above with reference to FIG. 4. For instance, the segment SEG1 and the segment SEG2 are stored in areas, respectively, where a segment SEG6 and a segment SEG5 are stored in FIG. 3.

The control component 210 in accordance with an embodiment may control target map data groups not to be stored in the second region 222, when the sum of the sizes of a plurality of target map data groups is equal to or larger than the storage capacity of the second region 222. As exemplified in FIG. 2, map data corresponding to the third data DT3 may be the map data MD2048 to the map data MD4100, and map data groups including the map data MD2048 to the map data MD4100 are map data group MDG128 to map data group MDG256. That is to say, while 129 map data groups may be selected as target map data groups, since the size of the 129 map data groups exceeds the storage capacity of the second region 222, which is assumed to be able to store 16 map data groups, the control component 210 may control the 129 target map data groups not to be stored in the second region 222. Due to this fact, only the segment SEG1 and the segment SEG2 being target segments may be stored in the first region 221. According to an embodiment, the map data selection component 240 may not select target map data groups the size of which is equal to or larger than the storage capacity of the second region 222. Namely, map data groups may not be selected as target map data groups or may not be stored in the second region 222 by the control of the control component 210 even though they are selected as target map data groups.

According to an embodiment, the map data selection component 240 may select a target map data group depending on whether a plurality of map data in a map data group are sequential or not. For instance, when the plurality of map data are sequential, the map data group including the plurality of map data may not be selected as a target map data group.

According to an embodiment, by dividing a map cache into two regions and separately storing a map data group which is selected, among map data groups in a segment stored in the first region 221, by a set or predetermined condition, in the second region 222 for a set or predetermined period, it is possible to solve a problem caused by frequent access to the nonvolatile memory device 300 for caching map data. As a result, the efficiency of the memory system 100 may be is improved.

According to an embodiment, by differently setting units by which data (a segment and a map data group) are stored in the first region 221 and the second region 222, only minimum data (a map data group) including specific map data which is frequently hit and is necessary to be separately stored in the second region 222 may be stored in the second region 222. As a result, it is possible to efficiently use the storage space of the random access memory 220 to better accommodate the trend toward minimization of a capacity and to allocate more resources for other operations of the memory system 100. In doing so, the performance of the memory system 100 may be improved.

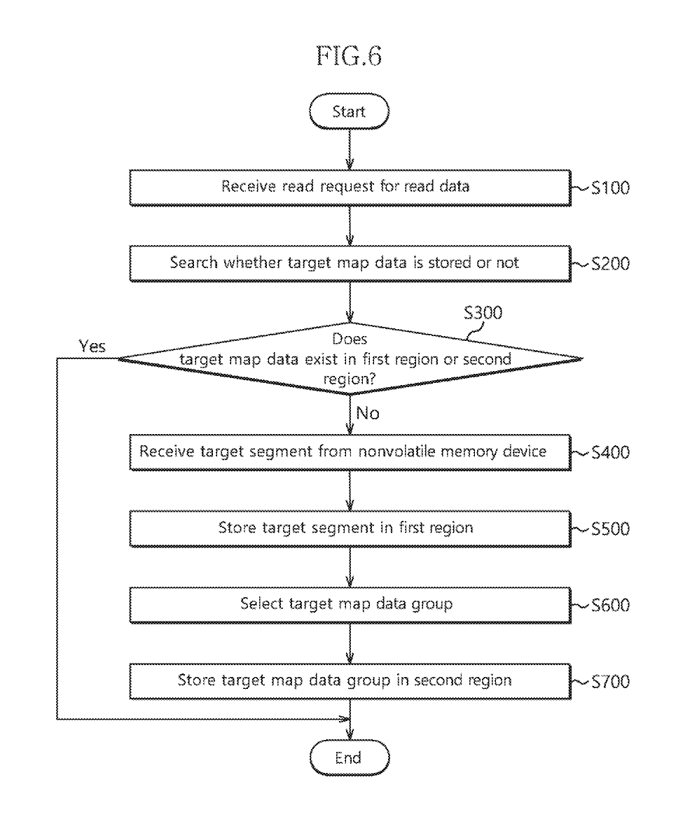

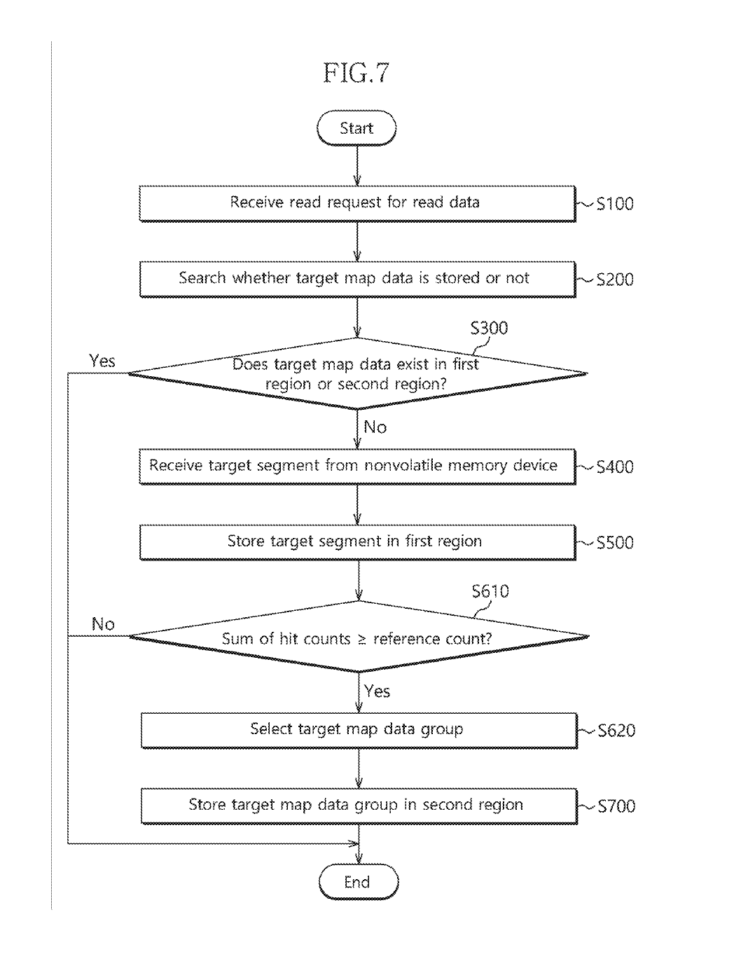

FIGS. 6 and 7 are flow charts to assist in the explanation of methods for operating a memory system in accordance with embodiments.

Referring to FIGS. 1 and 6, a method for operating the memory system 100 in accordance with an embodiment may include receiving, by the controller 200, a read request for read data from the host device 400 at step S100, searching, by the map data search component 230, the first region 221 and the second region 222 for target data at step S200 to determine whether target map data is stored therein or not at step S300, receiving a target segment including the target map data from the nonvolatile memory device 300 when the target map data does not exist in the first region 221 or the second region 222 at step S400, storing the received target segment in the first region 221 at step S500, selecting, by the map data selection component 240, a target map data group among the plurality of map data groups in the target segment at step S600, and storing the selected target map data group in the second region 222 at step S700.

Referring to FIGS. 1 and 7, a method for operating the memory system 100 in accordance with an embodiment may include receiving, by the controller 200, a read request for read data from the host device 400 at step S100, searching, by the map data search component 230, the first region 221 and the second region 222 to determine whether target map data is stored therein or not at steps S200 and S300, receiving a target segment including the target map data from the nonvolatile memory device 300 when the target map data does not exist in the first region 221 or the second region 222 at step S400, storing the received target segment in the first region 221 at step S500, determining the sum of hit counts of the plurality of map data in a map data group and comparing the sum of hit counts with a reference count, by the map data selection component 240 at step S610, selecting a map data group having a hit count sum that is greater than or equal to the reference count, as a target map data group at step S620, and storing the selected target map data group in the second region 222 at step S700.

According to an embodiment, a method for operating the memory system 100 may further include receiving, by the controller 200, a new target segment including new target map data from the nonvolatile memory device 300, determining the available capacity of the first region 221, determining an area where the new target segment is to be stored, based on hit counts of the segments stored in the first region 221, when the first region 221 is full, and storing the new target segment in the determined area. According to an embodiment, an area where a segment having the lowest hit count is stored may be determined as an area where the new target segment is to be stored. In another embodiment, an area where the oldest segment is stored in the first region 221 may be determined as an area where the new target segment is to be stored.

According to an embodiment, a method for operating the memory system 100 may further include receiving, by the controller 200, a new target segment including new target map data from the nonvolatile memory device 300, storing the new target segment in the first region 221, selecting a new target map data group among the plurality of map data groups in the new target segment, determining the available capacity of the second region 222, determining an area where the new target map data group is to be stored, based on hit counts of the map data groups stored in the second region 222, when the second region 222 is full, and storing the new target map data group in the determined area. For instance, an area where a map data group having the lowest hit count is stored may be determined as an area where the new target map data group is to be stored. According to an embodiment, an area where the oldest map data group is stored in the second region 222 may be determined as an area where the new target map data group is to be stored.

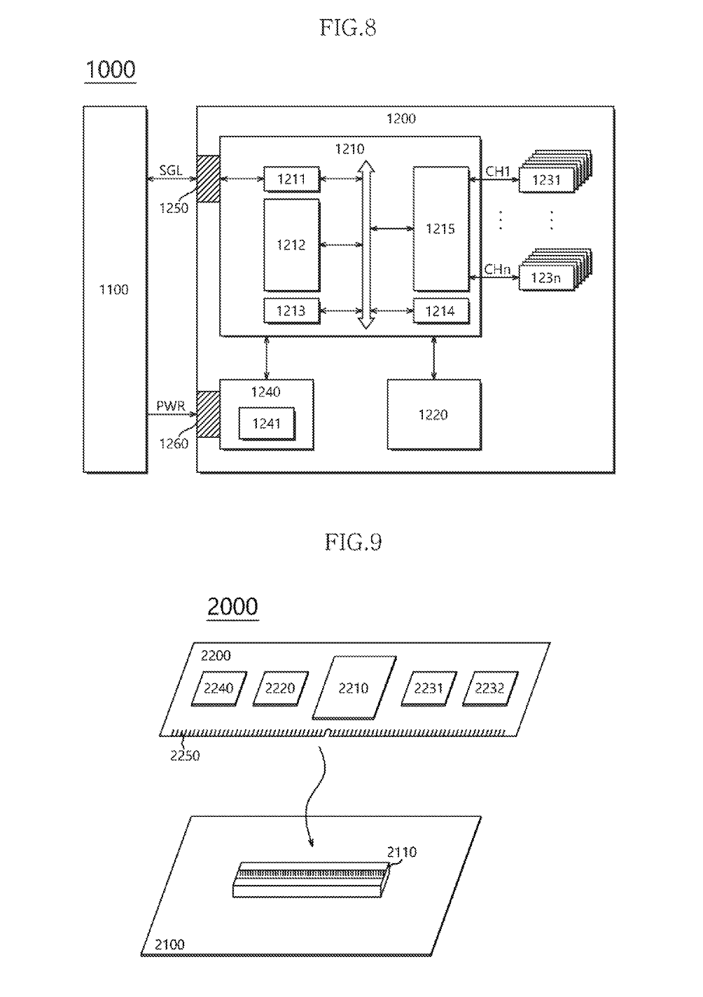

FIG. 8 is a diagram illustrating a data processing system including a solid state drive (SSD) in accordance with an embodiment. Referring to FIG. 8, a data processing system 1000 may include a host device 1100 and an SSD 1200.

The SSD 1200 may include a controller 1210, a buffer memory device 1220, nonvolatile memory devices 1231 to 123n, a power supply 1240, a signal connector 1250, and a power connector 1260.

The controller 1210 may control general operations of the SSD 1200. The controller 1210 may include a host interface 1211, a control component 1212, a random access memory 1213, an error correction code (KC) component 1214, and a memory control component 1215.

The host interface 1211 may exchange a signal SGL with the host device 1100 through the signal connector 1250. The signal SGL may include a command, an address, data, and so forth. The host interface 1211 may interface the host device 1100 and the SSD 1200 according to the protocol of the host device 1100. For example, the host interface 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (DATA), serial advanced technology attachment (SATA), small computer system interface (SCSI), serial attached SCSI (SAS), peripheral component interconnection (PCI), PCI express (PCI-E) and universal flash storage (UFS).

The control component 1212 may analyze and process a signal SGL inputted from the host device 1100. The control component 1212 may control operations of internal function blocks according to a firmware or a software for driving the SSD 1200. The random access memory 1213 may be used as a working memory for driving such a firmware or software.

The error correction code (ECC) component 1214 may generate the parity data of data to be transmitted to the nonvolatile memory devices 1231 to 123n. The generated parity data may be stored together with the data in the nonvolatile memory devices 1231 to 123n. The error correction code (ECC) component 1214 may detect an error of the data read out from the nonvolatile memory devices 1231 to 123n based on the parity data. If a detected error is within a correctable range, the error correction code (ECC) component 1214 may correct the detected error.

The memory control component 1215 may provide control signals such as commands and addresses to the nonvolatile memory devices 1231 to 123n, according to the control of the control component 1212. Moreover, the memory control component 1215 may exchange data with the nonvolatile memory devices 1231 to 123n, according to the control of the control component 1212. For example, the memory control component 1215 may provide the data stored in the buffer memory device 1220, to the nonvolatile memory devices 1231 to 123n, or provide the data read out from the nonvolatile memory devices 1231 to 123n, to the buffer memory device 1220.

The buffer memory device 1220 may temporarily store data to be stored in the nonvolatile memory devices 1231 to 123n. Further, the buffer memory device 1220 may temporarily store the data read out from the nonvolatile memory devices 1231 to 123n. The data temporarily stored in the buffer memory device 1220 may be transmitted to the host device 1100 or the nonvolatile memory devices 1231 to 123n according to the control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260 to the interior of the SSD 1200. The power supply 1240 may include an auxiliary power supply 1241. The auxiliary power supply 1241 may supply power to allow the SSD 1200 to be properly terminated when a sudden power-off occurs. The auxiliary power supply 1241 may include large capacity capacitors.

The signal connector 1250 may be configured as any of various types of connectors depending on an interface scheme between the host device 1100 and the SSD 1200.

The power connector 1260 may be configured as any of various types of connectors depending on a power supply scheme of the host device 1100.

FIG. 9 is a diagram illustrating a data processing system including a memory system in accordance with an embodiment. Referring to FIG. 9, a data processing system 2000 may include a host device 2100 and a memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control the general operations of the memory system 2200. The controller 2210 may be configured in the same manner as the controller 1210 shown in FIG. 8.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as the storage media of the memory system 2200.

The PMIC 2240 may provide the power inputted through the connection terminal 2250 to the interior of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and the like and power may be transferred between the host device 2100 and the memory system 2200. The connection terminal 2250 may be constructed as any of various types depending on an interface scheme between the host device 2100 and the memory system 2200. The connection terminal 2250 may be disposed on any side of the memory system 2200.

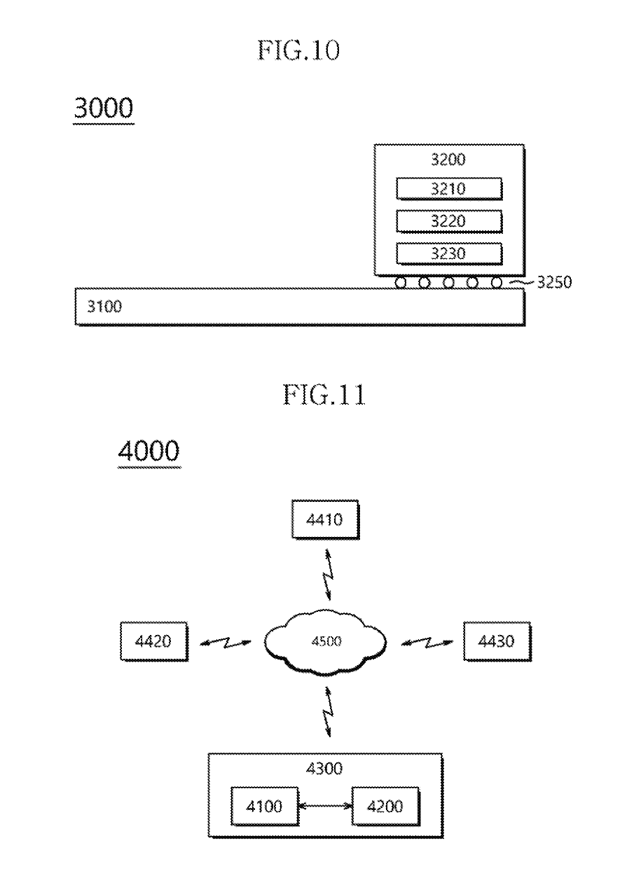

FIG. 10 is a diagram illustrating a data processing system including a memory system in accordance with an embodiment. Referring to FIG. 10, a data processing system 3000 may include a host device 3100 and a memory system 3200.

The host device 3100 may be configured in the form of a board such as a printed circuit board. Although not shown, the host device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control the general operations of the memory system 3200. The controller 3210 may be configured in the same manner as the controller 1210 shown in FIG. 8.

The buffer memory device 3220 may temporarily store data to be stored in the nonvolatile memory device 3230. Further, the buffer memory device 3220 may temporarily store the data read out from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

FIG. 11 is a diagram illustrating a network system including a memory system in accordance with an embodiment. Referring to FIG. 11, a network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 100 of FIG. 1, the SSD 1200 of FIG. 8, the memory system 2200 of FIG. 9 or the memory system 3200 of FIG. 10.

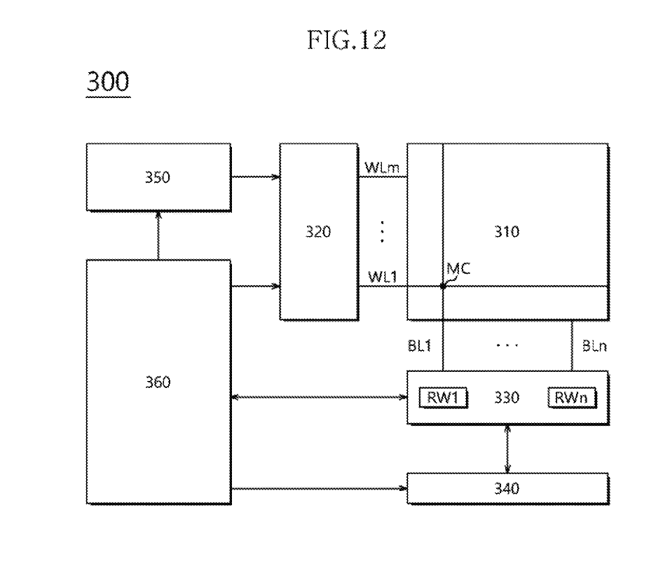

FIG. 12 is a block diagram illustrating a nonvolatile memory device included in a memory system in accordance with an embodiment. Referring to FIG. 12, a nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect.

The row decoder 320 may be coupled with the memory cell array 310 through the word lines WL1 to WLm. The row decoder 320 may operate according to the control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350 to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to the control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to the control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines (or data input/output buffers), based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For still another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control the general operations of the nonvolatile memory device 300, based on control signals provided from the external device. For example, the control logic 360 may control the read, write and erase operations of the nonvolatile memory device 300.

The description of the above-described system and functions of its components may be implemented as methods in accordance with embodiments described herein.

While various embodiments have been described above, it will be understood by those skilled in the art in light of the present disclosure that the described embodiments may be varied or modified in numerous ways. Accordingly, the present invention is not limited to the described embodiments. Rather, the present invention encompasses all such variations and modifications that fall within the scope of the claims.

What is claimed is:

1. A memory system comprising:
a nonvolatile memory device configured to store a plurality of segments each of which is configured by a plurality of map data;
a first region configured to cache a target segment including target map data among the plurality of segments;
a second region configured to cache a target map data group selected among a plurality of map data groups in the target segment; and
a controller configured to control data caching of the first region and the second region,
wherein each of plurality of map data groups includes a plurality of map data, and the second region caches data of a unit smaller than the first region.

2. The memory system according to claim 1, wherein the target map data includes mapping information on a physical address where read data is stored.

3. The memory system according to claim 1, further comprising:
a map data search component configured to search the first region or the second region for the target map data; and
a memory control component configured to transmit a read command for the target map data to the nonvolatile memory device, when the target map data is not stored in the first region or the second region.

4. The memory system according to claim 3, wherein the controller controls, when the target map data is searched by the map data search component, a read operation for the read data, to be performed based on the target map data stored in the first region or the second region.

5. The memory system according to claim 1, further comprising:
a map data selection component configured to select the target map data group to be stored in the second region,
is wherein the map data selection component selects, when a sum of hit counts of a plurality of map data in one map data group is equal to or greater than a reference count, the one map data group as the target map data group.

6. The memory system according to claim 5, wherein the map data selection component selects, when a plurality of map data groups each of which has a sum of hit counts equal to or greater than the reference count, each of the plurality of map data groups as the target map data group.

7. The memory system according to claim 6, wherein the controller controls, when a sum of sizes of the plurality of target map data groups is equal to or larger than a storage capacity of the second region, the target map data groups not to be stored in the second region.

8. The memory system according to claim 5, wherein the map data selection component selects the target map data group depending on whether a plurality of map data in a map data group are sequential.

9. The memory system according to claim 8, wherein the map data selection component does not select, when the plurality of map data are sequential, the map data group including the sequential plurality of map data as the target map data group.

10. The memory system according to claim 1, wherein the controller controls the target map data group to be provided to the second region when the first region is full.

11. The memory system according to claim 1, wherein the controller controls, after the target map data group is stored in the second region, a segment other than the target segment to be stored in an area in the first region where the target segment is stored.

12. The memory system according to claim 11, wherein the controller determines hit counts of respective segments stored in the first region, and determines erase priorities of the segments based on the hit counts.

13. The memory system according to claim 11, wherein the controller determines hit counts of respective map data groups stored in the second region, and determines erase priorities of the map data groups based on the hit counts.

14. The memory system according to claim 1, wherein a unit in which the second region caches data is a size of a map data group.

15. A method for operating a memory system, comprising:
searching, when a controller receives a read request for read data from a host device, a first region or a second region for target map data for an area where the read data is stored;
receiving, when the target map data is not stored in the first region and the second region, a target segment including the target map data from a nonvolatile memory device, by the controller;
storing the target segment in the first region;
selecting a target map data group among a plurality of map data groups in the target segment; and
storing the target map data group in the second region which caches data of a unit smaller than the first region,
wherein the target map data group includes the target map data.

16. The method according to claim 16, wherein the selecting of the target map data group comprises:
determining a sum of hit counts of a plurality of map data in a map data group; and
selecting, when the determined sum of hit counts is equal to or greater than a reference count, the map data group as the target map data group.

17. The method according to claim 16, wherein the selecting of the target map data group comprises:
determining whether a plurality of map data in each of the plurality of map data groups are sequential; and
selecting the target map data group based on whether the plurality of map data are sequential.

18. The method according to claim 16, further comprising:
receiving, by the controller, a new target segment including new target map data from the nonvolatile memory device;
determining an available capacity of the first region;
determining an area where the new target segment is to be stored based on hit counts of respective segments stored in the first region when the first region is full; and
storing the new target segment in the determined area.

19. The method according to claim 16, further comprising:
receiving, by the controller, a new target segment including new target map data from the nonvolatile memory device;
storing the new target segment in the first region;
selecting a new target map data group among a plurality of map data groups included in the new target segment;
determining an available capacity of the second region;
determining an area where the new target map data group is to be stored, based on hit counts of respective map data groups stored in the second region when the second region is full; and
storing the new target map data group in the determined area.

20. A memory system comprising:
a memory device configured to manage a plurality of map segments each including a plurality of map groups each having a plurality of map data;
a first cache configured to cache one or more among the map segments stored in the memory device in units of segments;
a second cache configured to cache one or more among the map groups cached in the first cache in units of map groups; and
a controller configured to:
find, in response to a read request, target map data from the second cache, the first cache, and then the memory device;
control the memory device to perform a read operation according to the target map data; and
control the first and second caches to respectively cache a segment and a map group including the target map data.
